(19) United States
(12) Patent Application Publication
(10) Pub. No.: US 2007/0152882 A1
(43) Pub. Date: Jul. 5, 2007

(54) Phased array antenna including transverse circuit boards and associated methods

(75) Inventors: Ronald J. Hash, Palm Bay, FL (US); Robert C. Taylor, Melbourne, FL (US); Anthony Mark Jones, Palm Bay, FL (US); Gregory M. Jandzio, Melbourne, FL (US); WILLIAM R. PALMER, MELBOURNE, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Harris Corporation, Melbourne, FL (US)

(21) Appl. No.: 11/324,998

(22) Filed: Jan. 3, 2006

(51) Int. Cl. H01Q 1/38

(52) U.S. Cl. 343/700 MS; 343/853

(57) ABSTRACT

A phased array antenna may include a substrate and a plurality of phased array antenna elements carried by the substrate. A plurality of intermediate circuit boards may be arranged in spaced apart relation and each may extend transversely from the substrate. Each intermediate circuit board may have a forward end connected to a plurality of respective phased array antenna elements. A rear circuit board may be connected to the plurality of intermediate circuit boards at rearward ends thereof opposite the substrate.

### FIELD OF THE INVENTION

The invention relates to the field of antennas, and, more particularly, to phased array antennas and related methods.

### BACKGROUND OF THE INVENTION

A phased array antenna comprises a group of antenna elements in which the relative phases of the respective signals feeding the antenna elements are varied thereby controlling the radiation pattern of the phased array antenna. The interface between the feed network and the antenna elements typically comprises connectors and cabling, and the connectors typically used may suffer from high signal loss. The connectors used for the interface may also be expensive and some antennas may require multiple connectors for each antenna element thereby adding complexity and/or cost to the antenna. In addition, space limitations on the antenna may result in size limitations on the connectors and/or make the removal of heat difficult.

U.S. Pat. No. 5,539,415 to Metzen et al. discloses a phased array device including a plurality of coaxial cables for providing input/output to a plurality of phased array elements. The phased array device also includes a heat sink between a plurality of electronic modules, and a plurality of bonded stacked printed circuit boards that form the beamforming network. The phased array device further includes a beamforming network interface comprising printed circuit boards that connect the plurality of electronic modules to the beamforming network through the heat sink.

U.S. Pat. No. 5,327,152 to Kruger et al. discloses an active aperture antenna including a plurality of antenna elements attached to one side of a support structure and a plurality of transmit/receive (T/R) modules attached to the other side of the support structure. The antenna elements are connected to the T/R modules by conductors passing through the support structure. In an alternative embodiment, the array elements may be mounted on a circuit board that is affixed to an upper surface of a support structure.

U.S. Pat. No. 6,483,464 to Rawnick et al. and assigned to the assignee of the present invention discloses a significant advance in phased array antennas. Each antenna unit of the phase array antenna comprises an antenna feed structure including a respective coaxial feed line for each antenna element and a feed line organizer body having passageways therein for receiving respective coaxial feed lines.

Unfortunately, the above described conventional phased array antennas may be limited by the interface between the antenna elements and the network feeding them. This interface may introduce signal loss and may add unnecessary complexity to the interface connection.

### SUMMARY OF THE INVENTION

In view of the foregoing background, it is therefore an object of the invention to provide a phased array antenna with an interface between the feed network and the antenna elements that has reduced signal loss, is relatively inexpensive, and may be easier to assemble than a conventional interface connector.

This and other objects, features, and advantages in accordance with the invention are provided by a phased array antenna that may comprise a substrate and a plurality of phased array antenna elements carried by the substrate. A plurality of intermediate circuit boards may be arranged in spaced apart relation and each may extend transversely from the substrate. Each intermediate circuit board may have a forward end connected to a plurality of respective phased array antenna elements. A rear circuit board may be connected to the plurality of intermediate circuit boards at rearward ends thereof opposite the substrate. Accordingly, a phased array antenna may be provided with an interface with the advantages mentioned above.

The substrate may comprise a dielectric layer carrying the phased array antenna elements on a front surface thereof. A ground plane may be on a back surface of the dielectric layer. The phased array antenna may further comprise at least one heat sink carried by each intermediate circuit board. Alternatively, a common heatsink may be coupled to two or more of the intermediate circuit boards.

The rear circuit board may comprise control circuitry for controlling the plurality of phased array antenna elements. Alternatively or in addition, each intermediate circuit board may comprise control circuitry for controlling the plurality of phased array antenna elements.

The intermediate circuit boards may each comprise at least one signal path between the substrate and the rear circuit board. The intermediate circuit boards each may further comprise a plurality of forward connectors on the forward end thereof, and a rearward connector on the rearward end thereof. The signal path may connect the plurality of forward connectors to the rearward connector. The plurality of forward connectors may comprise male connectors. Female connectors may mate with the male connectors and may be carried by the substrate. The rear circuit board may further comprise a plurality of connectors mating with the rearward connectors of the intermediate circuit boards.

The plurality of phased array antenna elements may comprise an array of dipole elements, for example. Each dipole element may comprise a medial feed portion and a pair of legs extending outwardly therefrom. Adjacent legs of adjacent dipole elements may include respective spaced apart end portions having predetermined shapes and relative positioning to provide increased capacitive coupling between the adjacent dipole elements.

A method aspect of the invention is directed to making a phased array antenna that may include a substrate and a plurality of phased array antenna elements carried by the substrate. The method may comprise arranging a plurality of intermediate circuit boards in spaced apart relation with each extending transversely from the substrate. Each intermediate circuit board may have a forward end connected to a plurality of respective phased array antenna elements. The method may further comprise connecting a rear circuit board to the plurality of intermediate circuit boards at rearward ends thereof opposite the substrate.

### BRIEF DESCRIPTION OF THE DRAWINGS

FIG. 1 is a schematic perspective view of a phased array antenna in accordance with the invention.

FIG. 2 is a top plan view of the phased array antenna of FIG. 1.

FIG. 3 is a greatly enlarged plan view of a portion of the array as shown in FIG. 2.

FIG. 4 is a side perspective view of the intermediate circuit board of the phased array antenna of FIG. 1.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

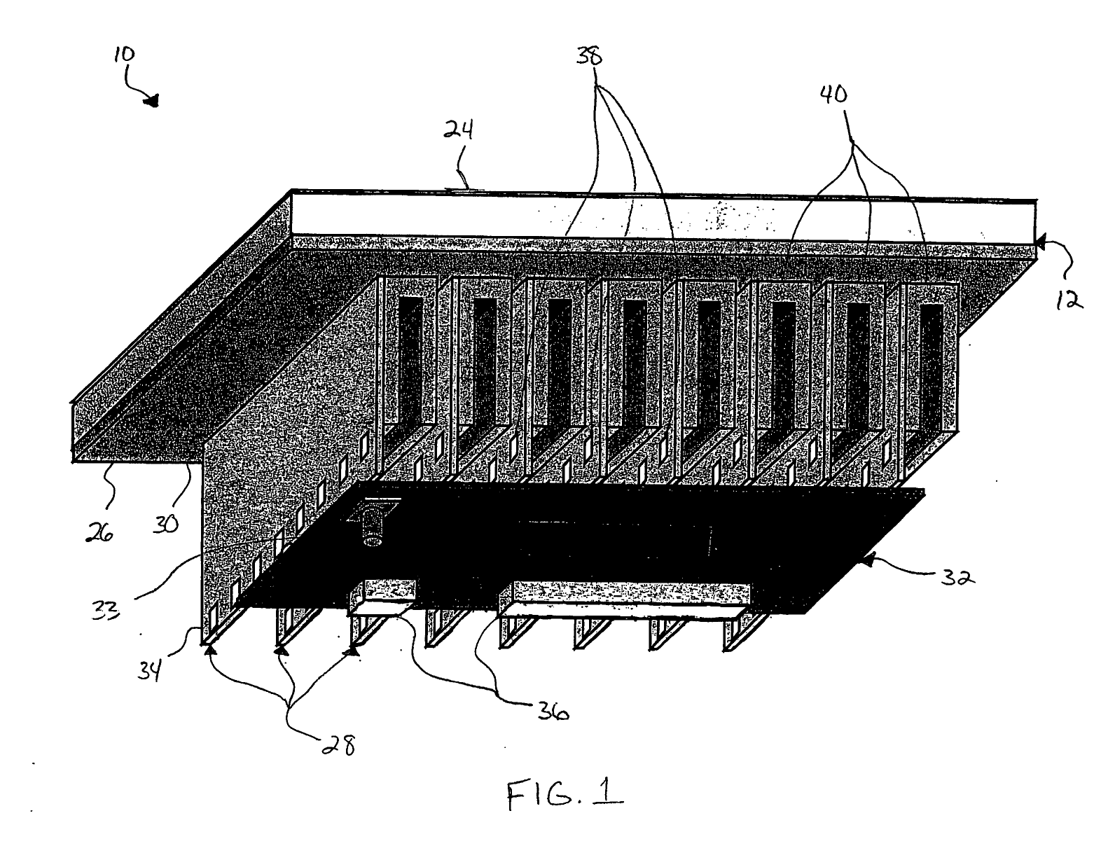

Referring to FIGS. 1-4, a phased array antenna 10 in accordance with the invention is now described. The phased array antenna 10 comprises a substrate 12 and a plurality of phased array antenna elements 14 carried by the substrate. The substrate 12 illustratively comprises a dielectric layer 24 carrying the phased array antenna elements 14 on a front surface thereof. An electrically conductive ground plane 26 is on a back surface of the dielectric layer 24.

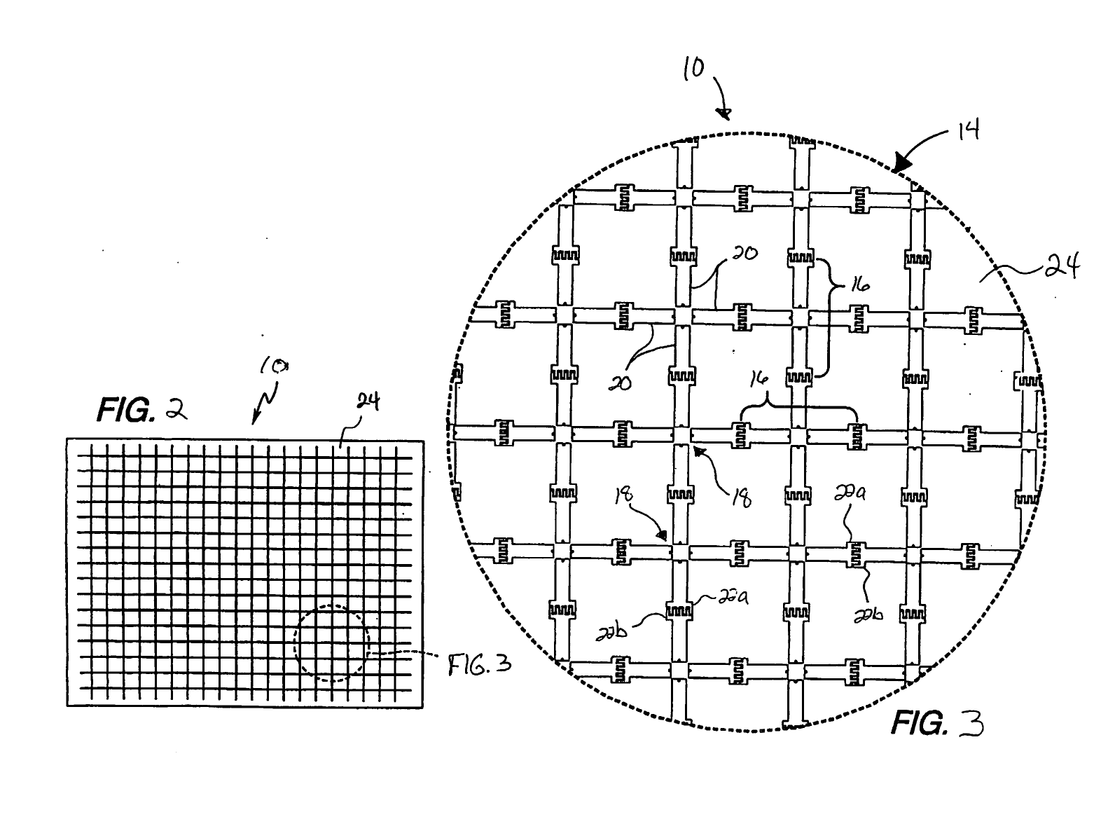

The plurality of phased array antenna elements 14 are illustrated in a particular spaced apart relation (FIG. 2), although other spacing and positioning of the plurality of phased array antenna elements is possible as will be appreciated by those of skill in the art. The plurality of phased array antenna elements 14 comprises an array of dipole elements 16 as is illustrated in greater detail in the enlarged view of a portion of the plurality of phased array antenna elements 14 in FIG. 3. Each dipole element 16 comprises a medial feed portion 18 and a pair of legs 20 extending outwardly therefrom. Adjacent legs of adjacent dipole elements 16 may include respective spaced apart end portions 22a, 22b having predetermined shapes and relative positioning to provide increased capacitive coupling between the adjacent dipole elements as will be appreciated by those of skill in the art. Such dipole elements 16 are more fully described in U.S. Pat. No. 6,512,487 to Taylor et al., assigned to the assignee of the present invention, and the entire contents of which is incorporated herein by reference.

A plurality of intermediate circuit boards 28 are arranged in spaced apart relation and each may extend transversely from the substrate 12 (FIG. 1). Each intermediate circuit board 28 has a forward end 30 connected to a plurality of respective phased array antenna elements 14. In one embodiment, the forward ends 30 are connected to the plurality of respective phased array antenna elements 14 with a push on connector, a flexible circuit, a wire, a ribbon, an epoxy, a solder, or the like, for example. This produces a hardwired connection without the need for a conventional mechanical coupler such as a radio frequency connector and/or cables.

The phased array antenna 10 may further comprise a heat sink 40 carried by each intermediate circuit board 28 as will be appreciated by those of skill in the art. In the illustrated embodiment, each heat sink 40 may have a U-shape. In other embodiments, the heat sink 40 may have other shapes. In addition, in yet other embodiments, the heat sink 40 may not be needed.

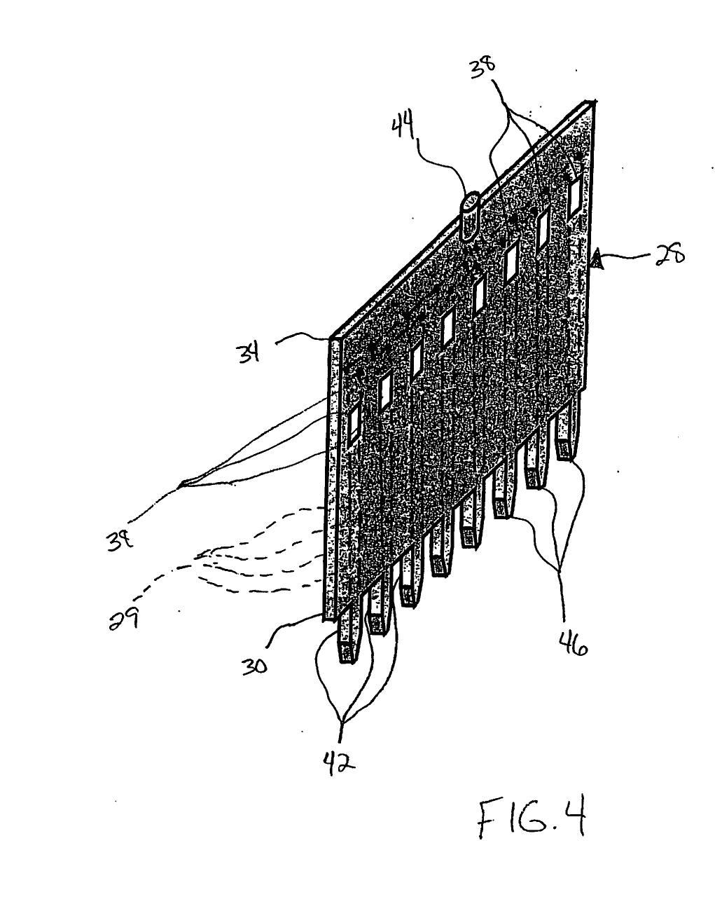

A rear circuit board 32 is connected to the plurality of intermediate circuit boards 28 at rearward ends 34 thereof opposite the substrate 12. As a result, the intermediate circuit boards 28 may each comprise one or more signal paths 29 between the substrate 12 and the rear circuit board 32 (FIG. 4).

The rear circuit board 32 includes a circuitry connector 33 for providing a signal path to upstream/downstream circuitry (not shown). In one embodiment, the rearward ends of the plurality of the intermediate circuit boards 28 are connected to the to upstream/downstream circuitry with a push on connector, a flexible circuit, a wire, a ribbon, an epoxy, a solder, or the like, for example. This produces a hardwired connection without the need for a conventional mechanical coupler such as a radio frequency connector and/or cables.

The rear circuit board 32 may comprise control circuitry 36 for controlling the plurality of phased array antenna elements 14 as will be appreciated by those of skill in the art. Alternatively or in addition, each intermediate circuit board 28 may comprise control circuitry 38 for controlling the plurality of phased array antenna elements 14.

Each intermediate circuit board 28 may further comprise a plurality of forward connectors 42 on the forward end 30 thereof, and a rearward connector 44 on the rearward end 34 thereof. In other embodiments, the intermediate circuit boards 28 may include a plurality of rearward connectors 44. As will be appreciated by those of skill in the art, each rear circuit board 32 connector would mate with a respective rearward connector of the intermediate circuit board 28. The plurality of forward connectors 42 may comprise male or female connectors 46 and the plurality of phased array antenna elements 14 may further comprise female or male connectors (not shown) mating therewith and carried by the substrate 12.

A method aspect of the invention is directed to making a phased array antenna 10 that may include a substrate 12 and a plurality of phased array antenna elements 14 carried by the substrate. The method may comprise arranging a plurality of intermediate circuit boards 28 in spaced apart relation with each extending transversely from the substrate 12. Each intermediate circuit board 28 may have a forward end 30 connected to a plurality of respective phased array antenna elements 14. The method may further comprise connecting a rear circuit board 32 to the plurality of intermediate circuit boards 28 at rearward ends 34 thereof opposite the substrate 12.

The phased array antenna 10 and associated method may provide more cost effective and compact interfacing with relatively small and densely packed antenna elements. Accordingly, many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A phased array antenna comprising:
a substrate and a plurality of phased array antenna elements carried by said substrate;
a plurality of intermediate circuit boards arranged in spaced apart relation and extending transversely from said substrate, each intermediate circuit board having a forward end connected to a plurality of respective phased array antenna elements and a rearward end opposite the forward end; and
a rear circuit board connected to said plurality of intermediate circuit boards at rearward ends thereof opposite said substrate.

2. The phased array antenna according to claim 1 wherein said substrate comprises:
a dielectric layer carrying said phased array antenna elements on a front surface thereof; and
a ground plane on a back surface of said dielectric layer.

3. The phased array antenna according to claim 1 further comprising at least one heat sink carried by each intermediate circuit board.

4. The phased array antenna according to claim 1 wherein said rear circuit board comprises control circuitry for controlling the plurality of phased array antenna elements.

5. The phased array antenna according to claim 1 wherein each intermediate circuit board comprises control circuitry for controlling the plurality of phased array antenna elements.

6. The phased array antenna according to claim 1 wherein said intermediate circuit boards each comprises at least one signal path between said substrate and said rear circuit board.

7. The phased array antenna according to claim 6 wherein said intermediate circuit boards each further comprises a plurality of forward connectors on the forward end thereof, and at least one rearward connector on the rearward end thereof; and wherein said at least one signal path connects said plurality of forward connectors to said at least one rearward connector.

8. The phased array antenna according to claim 6 wherein said rear circuit board further comprises a plurality of connectors mating with said rearward connectors of said intermediate circuit boards.

9. The phased array antenna according to claim 1 wherein said plurality of phased array antenna elements comprises an array of dipole elements, each comprising a medial feed portion and a pair of legs extending outwardly therefrom, adjacent legs of adjacent dipole elements including respective spaced apart end portions having predetermined shapes and relative positioning to provide increased capacitive coupling between the adjacent dipole elements.

10. A phased array antenna comprising:
a substrate and a plurality of phased array antenna elements carried by said substrate;
a plurality of intermediate circuit boards arranged in spaced apart relation and extending transversely from said substrate, each intermediate circuit board having a forward end connected to a plurality of respective phased array antenna elements and a rearward end opposite the forward end;
each intermediate circuit board comprising first control circuitry for controlling the plurality of phased array antenna elements; and
a rear circuit board connected to said plurality of intermediate circuit boards at rearward ends thereof opposite said substrate;
said rear circuit board comprising second control circuitry for controlling the plurality of phased array antenna elements in cooperation with said first control circuitry.

11. The phased array antenna according to claim 10 wherein said substrate comprises:
a dielectric layer carrying said phased array antenna elements on a front surface thereof; and
a ground plane on a back surface of said dielectric layer.

12. The phased array antenna according to claim 10 further comprising at least one heat sink carried by each intermediate circuit board.

13. The phased array antenna according to claim 10 wherein said intermediate circuit boards each comprises at least one signal path between said substrate and said rear circuit board.

14. The phased array antenna according to claim 13 wherein said intermediate circuit boards each further comprises a plurality of forward connectors on the forward end thereof, and at least one rearward connector on the rearward end thereof; and wherein said at least one signal path connects said plurality of forward connectors to said at least one rearward connector.

15. The phased array antenna according to claim 13 wherein said rear circuit board further comprises a plurality of connectors mating with said rearward connectors of said intermediate circuit boards.

16. The phased array antenna according to claim 10 wherein said plurality of phased array antenna elements comprises an array of dipole elements, each comprising a medial feed portion and a pair of legs extending outwardly therefrom, adjacent legs of adjacent dipole elements including respective spaced apart end portions having predetermined shapes and relative positioning to provide increased capacitive coupling between the adjacent dipole elements.

17. A method of making a phased array antenna comprising a substrate and a plurality of phased array antenna elements carried by the substrate, the method comprising:
arranging a plurality of intermediate circuit boards in spaced apart relation and extending transversely from the substrate, each intermediate circuit board having a forward end connected to a plurality of respective phased array antenna elements; and
connecting a rear circuit board to the plurality of intermediate circuit boards at rearward ends thereof opposite the substrate.

18. The method according to claim 17 further comprising connecting at least one heat sink adjacent to each intermediate circuit board.

19. The method according to claim 17 wherein the plurality of phased array antenna elements comprises an array of dipole elements, each comprising a medial feed portion and a pair of legs extending outwardly therefrom, adjacent legs of adjacent dipole elements including respective spaced apart end portions having predetermined shapes and relative positioning to provide increased capacitive coupling between the adjacent dipole elements.
